(19) United States
(12) Patent Application Publication
(10) Pub. No.: US 2025/0348959 A1
(43) Pub. Date: Nov. 13, 2025

(54) AI-BASED HOTEL MANAGEMENT SYSTEM AND METHOD

(71) Applicant: AI REV Corporation, Lawndale, CA (US)

(72) Inventor: Yaping Wang, Lawndale, CA (US)

(21) Appl. No.: 19/201,809

(22) Filed: May 7, 2025

Related U.S. Application Data
(60) Provisional application No. 63/643,521, filed on May 7, 2024.

(51) Int. Cl. G06Q 50/12; G06F 3/0482; G06F 3/0484; G06Q 30/0201

(52) U.S. Cl. CPC G06Q 50/12; G06F 3/0482; G06F 3/0484; G06Q 30/0206

(57) ABSTRACT

An AI-based hospitality management system and method for providing tools to manage, optimize, and streamline hospitality performance, resulting in improved revenue models, as well as increased customer satisfaction. The system and method offer a dual interface, catering to both management and guests. For management, it provides tangible tools to receive and analyze competing amenity provider rates and services, and to implement in-house amenity rate change records to update its own in-house service rates thereby improving revenue. The guest profiles are centralized, and communication streamlined through automated responses and analysis of guest reviews via machine learning algorithms, thereby providing personalized recommendations, assistance with inquiries, and facilitating communication with the front desk.

### CROSS-REFERENCE TO RELATED APPLICATIONS

This application claims the benefit of U.S. Provisional patent application No. 63/643,521, filed May 7, 2024, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### TECHNICAL FIELD

The present invention relates to the field of hospitality, including a system and method of hospitality management and guest services.

### BACKGROUND

Currently, the hospitality industry lacks a comprehensive and integrated solution for effective hotel management and guest services. Existing systems often lack real-time data analysis, predictive capabilities, and personalized guest interactions. Hotel management faces challenges in monitoring competitors, adjusting pricing strategies dynamically, and efficiently responding to guest inquiries and feedback. Guests encounter difficulties in obtaining relevant information about their stay, accessing hotel services, and receiving prompt assistance.

The fragmented management tools in current hotel management systems necessitate hoteliers to navigate through disparate platforms for tasks ranging from revenue management to competitor analysis and guest profiling, resulting in inefficiencies and complexity. Moreover, limited guest engagement ensues as guests encounter difficulties accessing pertinent information about the hotel and local attractions, contributing to dissatisfaction and diminished loyalty. Manual processes for revenue management, including competitor rate monitoring and market trend analysis, prove inefficient and often lead to missed revenue optimization opportunities. Furthermore, ineffective guest feedback mechanisms characterized by cumbersome traditional channels result in underutilization and incomplete insights into guest experiences, hindering improvements in service quality.

Therefore, to remedy the aforementioned disadvantageous aspects of the conventional tools and practices, there is a need for an AI-based hotel management system designed to streamline operations and enhance guest experiences.

### SUMMARY OF THE INVENTION

The present invention discloses an artificial intelligent based hotel management system. The AI-based hotel management system may offer a dual interface, catering to both management and guests. For management, the AI-based system may be configured to receive data on hotel occupancy, Average Daily Rate (ADR), Revenue Per Available Room (RevPAR), comparative statistics for relevant competitors of the hotel, and current conditions (i.e., such as weather, scheduled events, etc.), in order to optimize room rates and generally provide real-time data on hotel performance, competitor rates, and local events, facilitating proactive revenue or RevPAR optimization and management in seamless integration with other existing booking platforms. This may be achieved by way of an AI module that may be adapted for training via an accelerator module of the AI to which existing historical data (for example and without limitation STR reports or the like) may be provided. Additionally, the AI module may employ an algorithm whereby the AI-based system deploys one or more crawlers throughout the Internet to retrieve current real-time information from numerous sources-including but not limited to real-time or approximate real-time hotel room pricing information of competitors, weather reports, flight delays, scheduled events like sports games or concerts-in order for the AI-based system to incorporate into its analysis. The system can be adapted to suit the needs of any spatial rental situation from a seat on any public transportation to renting a room from residential properties.

For guests-and more importantly assistance to management in handling certain guest requests, guest profiles may be centralized, and communication streamlined through automated responses and analysis of guest reviews via machine learning algorithms. By automating routine tasks and enhancing guest experience, the system addresses diverse needs in the hospitality industry, thereby improving efficiency and service quality.

For the purposes of this specification, the term amenity will mean any service that may be provided by any hospitality provider. For example, an amenity may include an overnight stay accommodation (e.g., a rented hotel room), a guest service (e.g., a massage), goods (e.g., in-room refreshments), transportation (e.g., airport transport to and from the hotel), etc. In addition, the term amenity provider (or similar) will mean any entity that provides such amenities to its customers (e.g., hotels, other room rental services, online travel agents, other types of travel aggregators, spas, transportation services, etc.).

It also is appreciated that the inventive system and method described herein invention can be used for any quantifiable booking service or space rental, from renting private residential spaces like Airbnb, Apartment rentals, ride shares, commercial leases, room(s) onboard a cruise ship, to renting out seats in an airplane, rental cars, or other public mass transportation.

In exemplary embodiments, the system comprises a server in communication with a database. The system further comprises a first user device and a second user device. The first user device and the second user device are in communication with the server via a network, whether cloud-based or otherwise.

The server is configured to enable the first user to input search criteria for a search related to hotel accommodation. In an embodiment, the input search criteria include a preferred location of the hotel, date range, price range, accommodation type, amenities, star ratings, guest ratings, specific hotel brand preferences and special offers and deals. The server is further configured to display one or more hotels based on the input search criteria. The server further facilitates marking one or more hotels as a preferred accommodation and set a preferred price range to receive alerts. The server further provides information regarding events in a location proximal to the hotel booked by the first user.

The server further integrates with booking sources and monitors information related to the booking sources. In an example, the booking source is a third-party accommodation booking platform. The server further monitors prices of hotel accommodation at the booking sources. The server is configured to utilize predictive analysis for providing dynamic pricing of hotel accommodation based on the price range of booking sources. The server is further configured to automatically update to display real-time hotel prices, including parent hotel rates.

The server is further configured to connect with various Application Programming Interfaces (APIs) and enable the hotel management system to seamlessly integrate with external services and platforms to enhance operational efficiency and guest satisfaction. The server is further configured to collect information related to the first user and create a first user profile. The server is configured to collect contact information, address details, booking history including dates, room types, and booking channels, and residential or mailing addresses, including city, state, postal code, and country. The server is configured to aggregate first user profiles into a centralized dataset.

The server is further configured to generate reports and forecasts for hotel revenue and business analytics. The reports include, but not limited to, revenue report, occupancy report, forecast report and business analytics report. The server is further configured to provide a dashboard interface for responding to messages and reviews of the first user. The server further integrates with external review platforms, for example, TripAdvisor and Google Reviews, to analyze and report on guest feedback trends. In some exemplary embodiments, and without limiting the scope of the present invention, an AI-based algorithm may crawl online travel agency (OTA) websites to read guests reviews, draft and/or send reply notes, and or post on or in response to these reviews automatically and in real time with accurate, good quality language to enhance guests' experiences.

According to the present invention, a QR code is provided at the hotel room, and upon scanning the QR code, guests are seamlessly directed to the AI-powered concierge chat interface, where they can access a wide array of services and information. The system responds to guest queries about hotel amenities, provides recommendations, and facilitates communication with the front desk through text messaging. The present invention uses advanced machine learning algorithms to comprehensively analyze relevant data from the hotel's website and external sources to offer tailored suggestions and insights. Furthermore, it seamlessly integrates with third-party online travel agencies for convenient room bookings. Overall, the system enhances guest satisfaction by offering personalized assistance and valuable insights throughout their stay. The system enhances guest experience and also improves operational efficiency for hotel, or broadly hospitality, management. Similar application for Airbnb rentals it will notify all info to the host property owner. For situations such as seats on transport a QR code should be visible to the seated individual, upon scanning AI concierge can relay information of their destination, eta, delay notifications, take food order requests, and act as a virtual customer service agent, and if requested alert live staff's attention. For rental cars it can serve as an immediate direct contact help AI to the rental company.

Furthermore, according to one aspect, one or more embodiments are provided herein for a method, performed by a server and a plurality of user devices, for displaying and transacting an amenity rate change record by way of a graphical user interface (GUI) distributed to the plurality of client devices, comprising acquiring a list of competing online amenity providers, acquiring, by the server over a network using a network crawler, amenity rates corresponding to each of the competing online amenity providers, the amenity rates acquired successively at predetermined time intervals, calculating, by the server, an amenity rate change of each successive acquired amenity rate of each corresponding competing online amenity rate provider at each predefined time interval, generating, by the server, the amenity rate change record, the amenity rate change record including the acquired amenity rates, the calculated amenity rate changes, a statistical comparison of the acquired amenity rates and a current in-house amenity rate, and a proposed in-house amenity rate, transmitting, by the server via the network, the amenity rate change record to a client device configured to execute the GUI, wherein the client device automatically launches a first screen within the GUI in response to receiving the amenity rate change record via a notification, the first screen within the GUI comprising a user selection mechanism enabling a user of the client device to choose a competing online amenity provider from the list of competing online amenity providers, wherein the client device launches a second screen within the GUI in response to the user using the user selection mechanism to choose the competing online amenity provider, the second screen within the GUI comprising (A) a graphical representation of each calculated amenity rate change of the competing amenity provider chosen by the user, the calculated amenity rate change displayed according to each predetermined time interval, (B) a graphical representation of the acquired amenity rates and the proposed in-house amenity rate, the acquired amenity rates and the proposed in-house amenity rate displayed according to each predetermined time interval, (C) the statistical comparison of the acquired amenity rates and the current in-house amenity rate, (D) the proposed in-house amenity rate, (E) the user selection mechanism enabling the user of the client device to choose a different competing amenity provider from the list of competing amenity providers, and (F) an execute button to transact the amenity rate change record, wherein the client device launches a third screen within the GUI in response to the user using the user selection mechanism to choose the different competing amenity provider, the third screen within the GUI comprising (A)-(C) with regard to the different competing amenity provider and (D)-(F), transmitting, by the client device to the server via the network, in response to the user of the client device pressing the execute button on the GUI, a system command to transact the amenity rate change record within the server, wherein the client device launches a fourth screen within the GUI in response to the user pressing the execute rate change button, the fourth screen within the GUI comprising a confirmation that the system command to transact the amenity rate change record has been transmitted to the server, receiving from the client device, by the server via the network, the system command to transact the amenity rate change record within the server, and transacting, by the server, the amenity rate change record, wherein the transacting the amenity rate change record changes the current in-house amenity rate to match the proposed in-house amenity rate.

In another embodiment, the method further comprises transmitting to the client device, by the server via the network, a confirmation of the amenity rate change record transaction within the server, wherein the client device launches a fifth screen within the GUI in response to receiving the confirmation of the amenity rate change record transaction, the fifth screen within the GUI comprising a confirmation of the amenity rate change record transaction, and a generate new record button that when pressed causes the client device to transmit to the server via the network a system command to generate a new amenity rate change record within the server based on newly acquired amenity rates and including corresponding calculated newly acquired amenity rate changes, a statistical comparison of the newly acquired amenity rates and a new current in-house amenity rate, and a new proposed in-house amenity rate.

In another embodiment, the second screen within the GUI further comprises a graphical representation of a comparison of a first predicted revenue based on the current in-house amenity rate and a second predicted revenue based on a proposed transaction of the amenity rate change record, and/or a graphical representation of a comparison of a first predicted occupancy rate based on the current in-house amenity rate and a second predicted occupancy rate based on the proposed transaction of the amenity rate change record.

In another embodiment, the amenity rate is an overnight stay rate.

In another embodiment, the predefined time interval is one hour.

In another embodiment, the statistical comparison includes calculating an average, a median, a mode, and/or a standard deviation.

The presently disclosed system and method for evaluating growing media is more fully described in the detailed description below.

### BRIEF DESCRIPTION OF DRA WINGS

The following detailed description of the present invention is better understood when read in conjunction with the appended drawings. For the purpose of illustrating the present invention, exemplary constructions of the present invention are shown in the drawings. However, the present invention is not limited to the specific methods and structures disclosed herein.

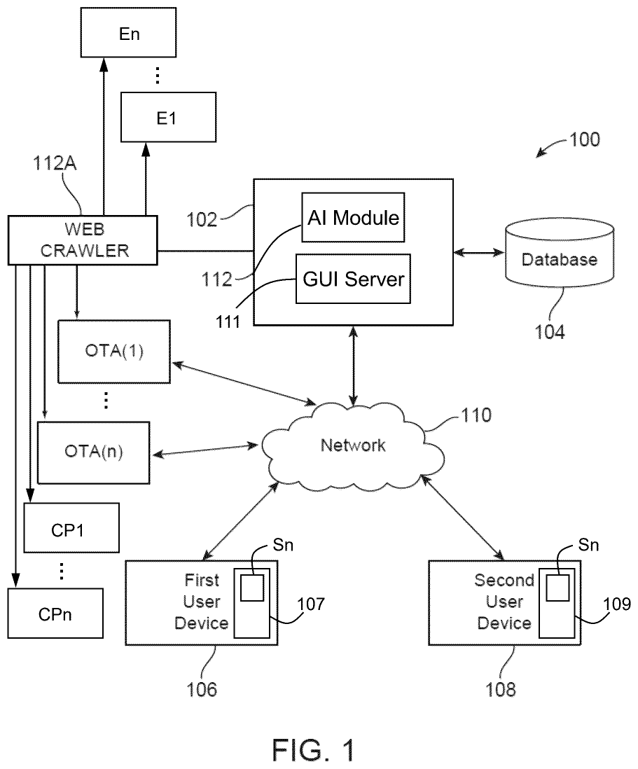

FIG. 1 exemplarily illustrates an environment of an artificial intelligent based hotel management system, according to an embodiment of the present invention.

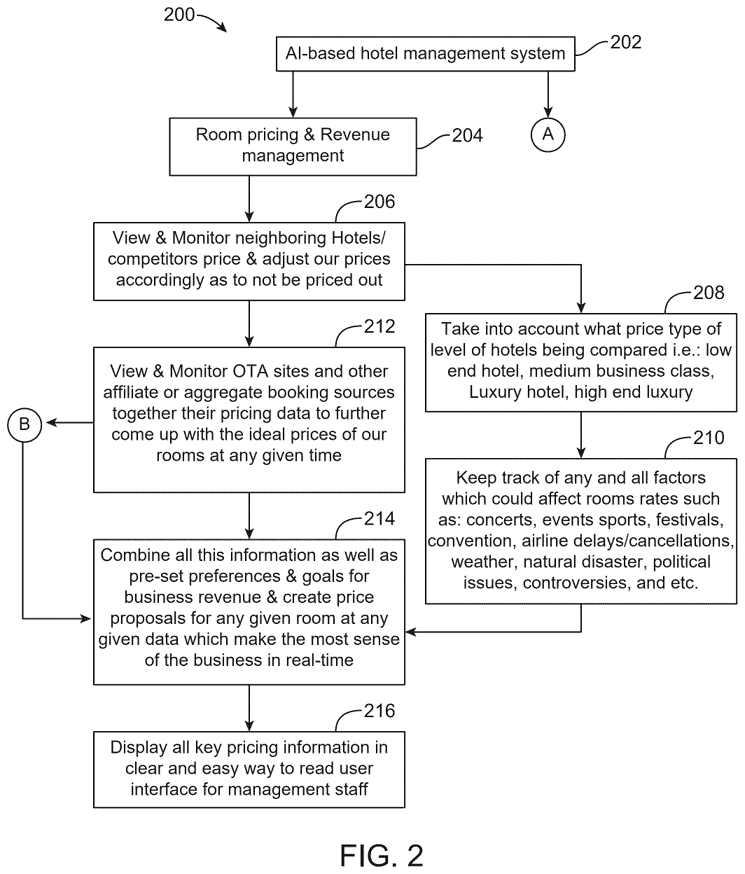

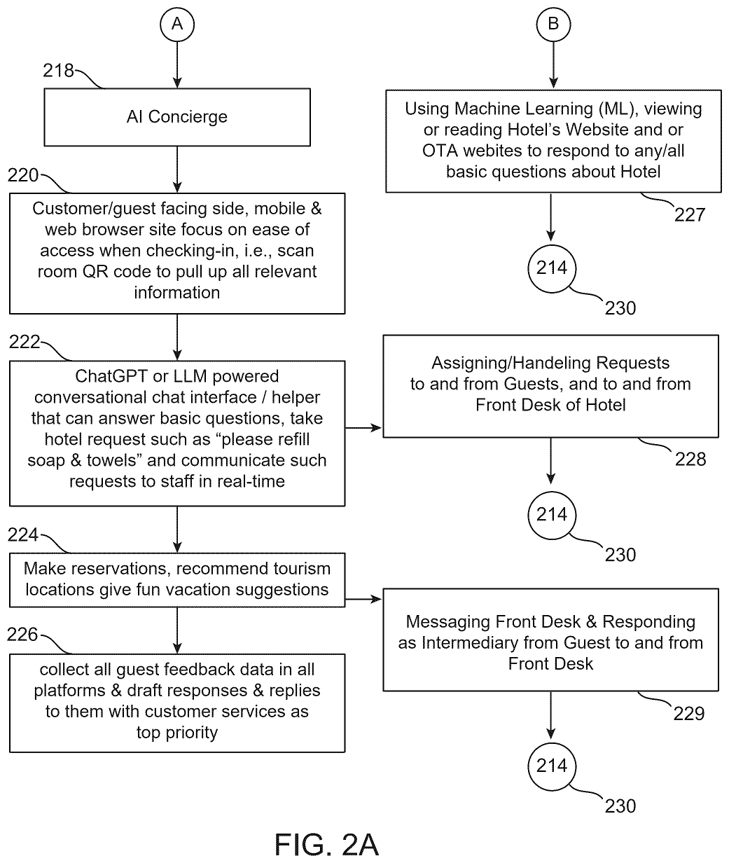

FIGS. 2 and 2A exemplarily illustrate a flowchart of a method for artificial intelligent based hotel management, according to an embodiment of the present invention.

FIG. 2B exemplarily illustrates two methods for autonomously accessing, reviewing, and responding to reviews and chat inquiries automatically, or optionally, automatically preparing each response for admin approval.

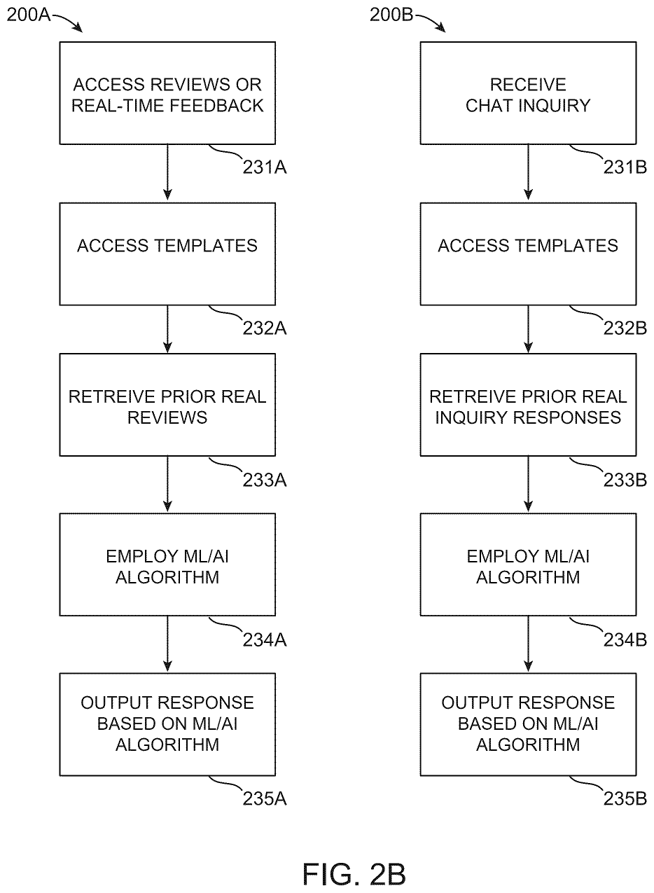

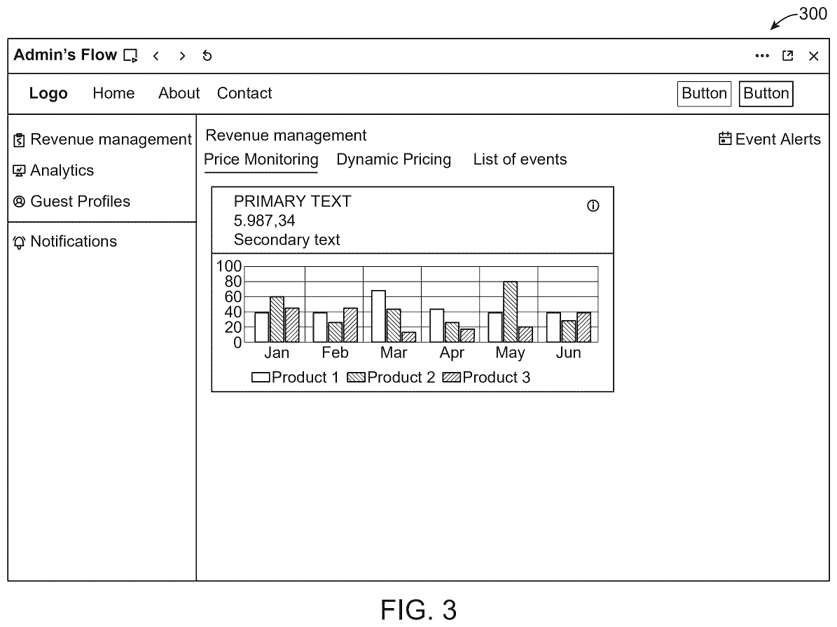

FIG. 3 exemplarily illustrates a screenshot of a user interface for monitoring price data, according to an embodiment of the present invention.

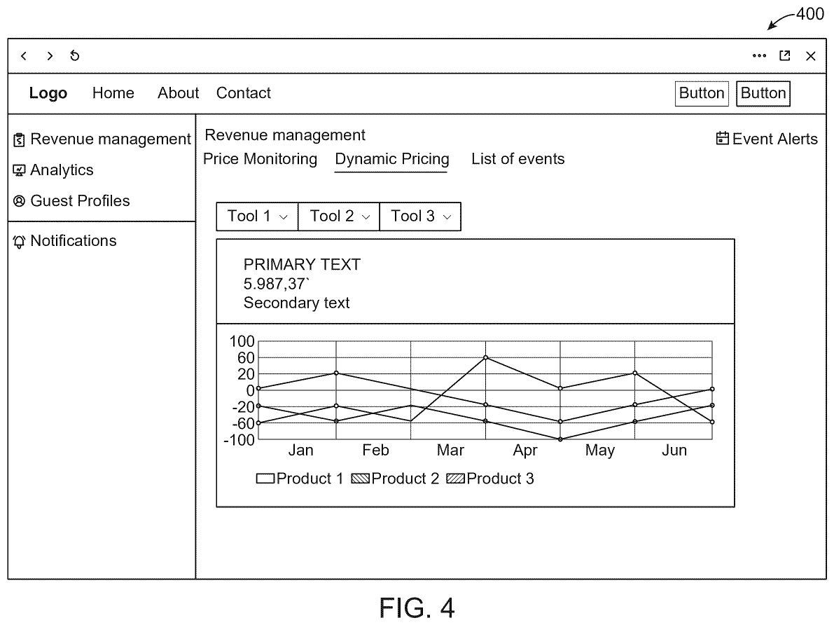

FIG. 4 exemplarily illustrates a screenshot of a user interface for monitoring dynamic price data, according to an embodiment of the present invention.

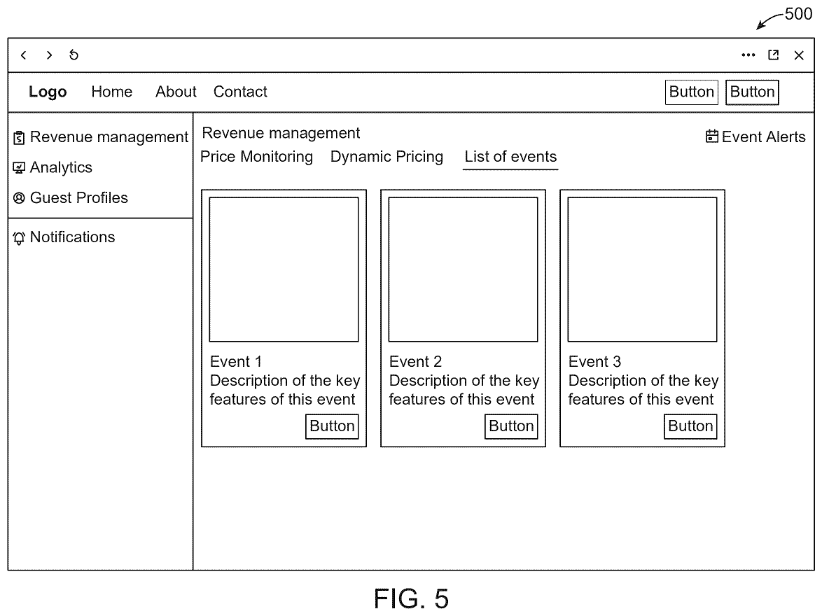

FIG. 5 exemplarily illustrates a screenshot of a user interface displaying list of events, according to an embodiment of the present invention.

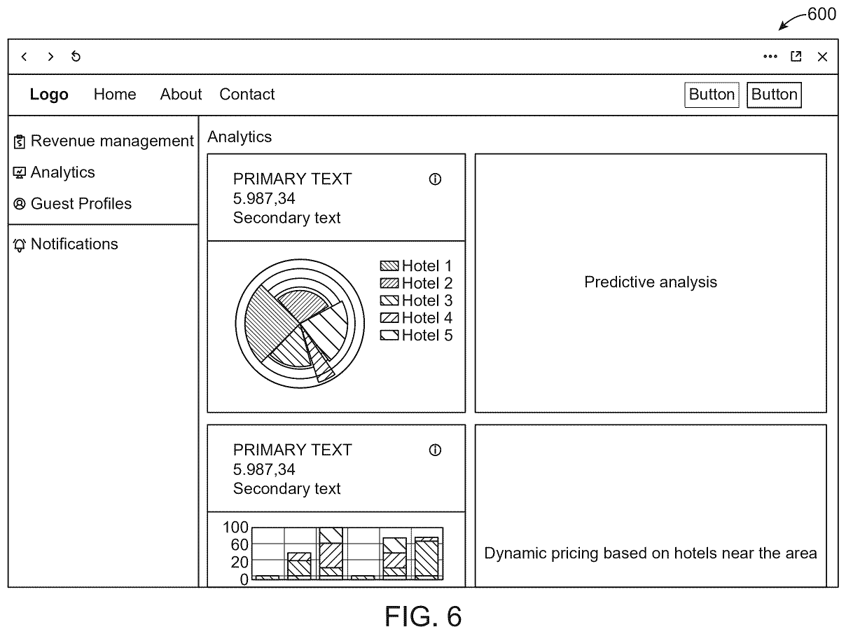

FIG. 6 exemplarily illustrates a screenshot of a user interface displaying dynamic pricing based on hotels near a predefined location using predictive analysis, according to an embodiment of the present invention.

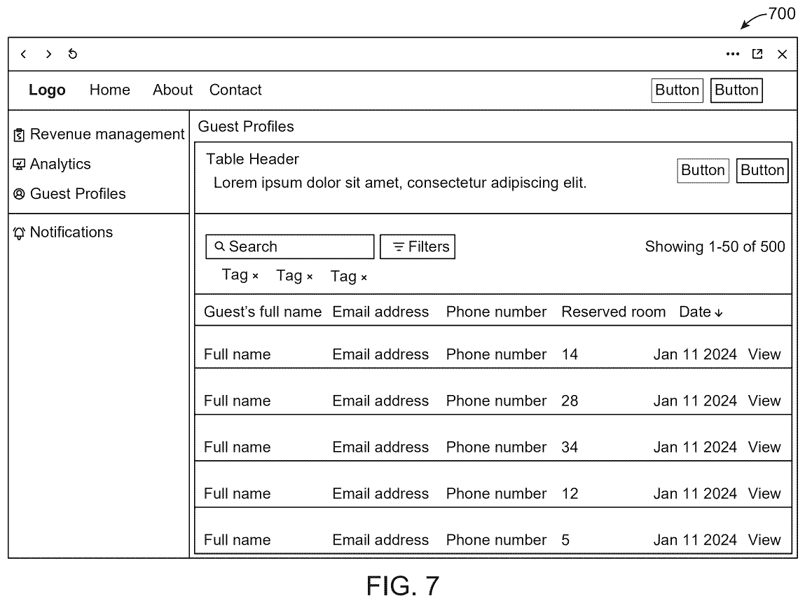

FIG. 7 exemplarily illustrates a screenshot of a user interface displaying first user profiles, according to an embodiment of the present invention.

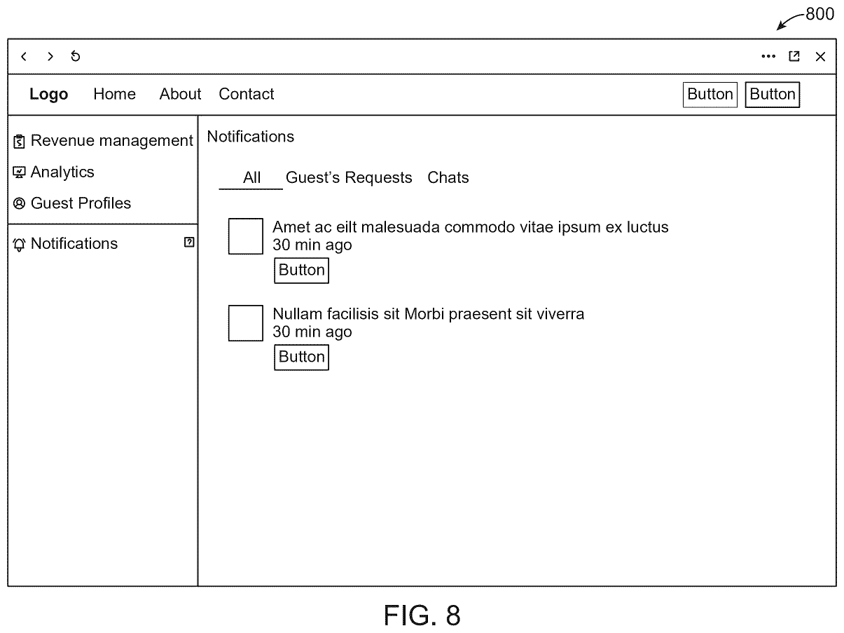

FIG. 8 exemplarily illustrates a screenshot of a user interface displaying notifications, according to an embodiment of the present invention.

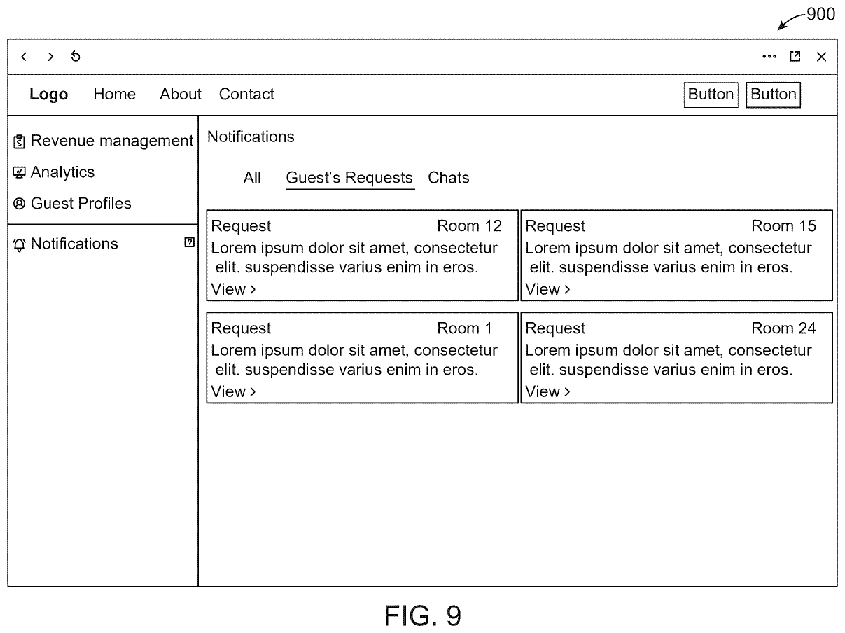

FIG. 9 exemplarily illustrates a screenshot of a user interface displaying a request of a first user, according to an embodiment of the present invention.

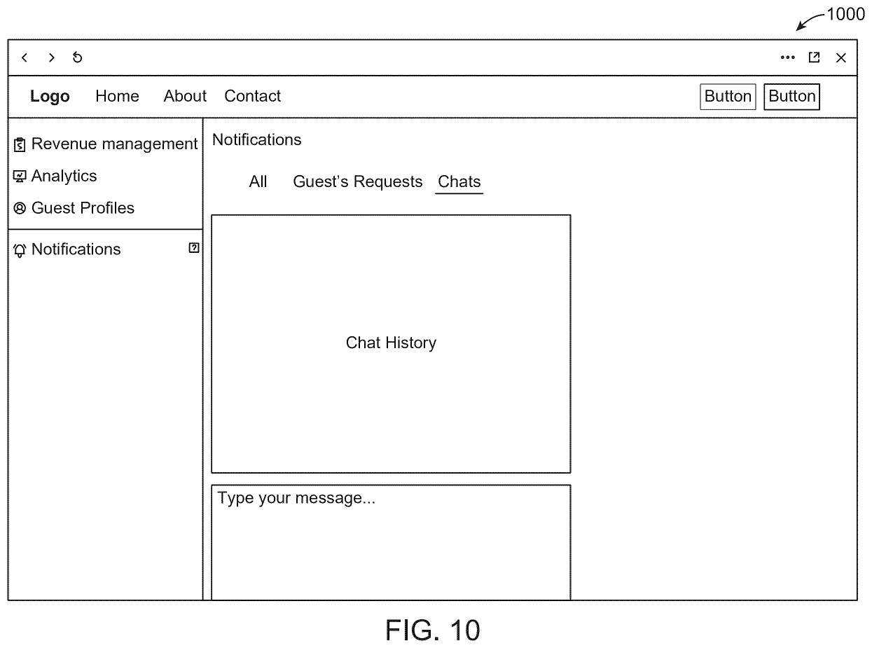

FIG. 10 exemplarily illustrates a screenshot of a user interface displaying a chat history of the first user and the second user, according to an embodiment of the present invention.

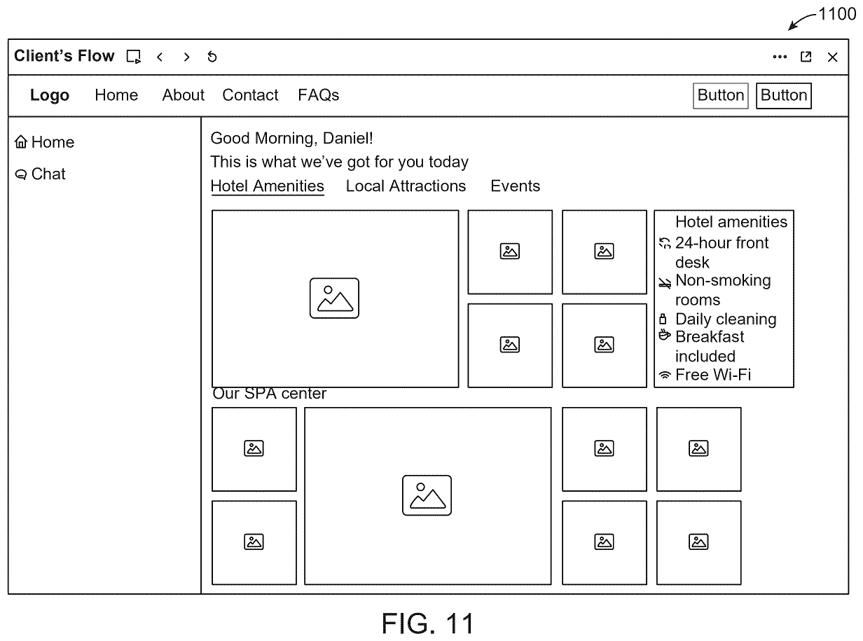

FIG. 11 exemplarily illustrates a screenshot of a user interface displaying information related to hotel accommodation to the first user, according to an embodiment of the present invention.

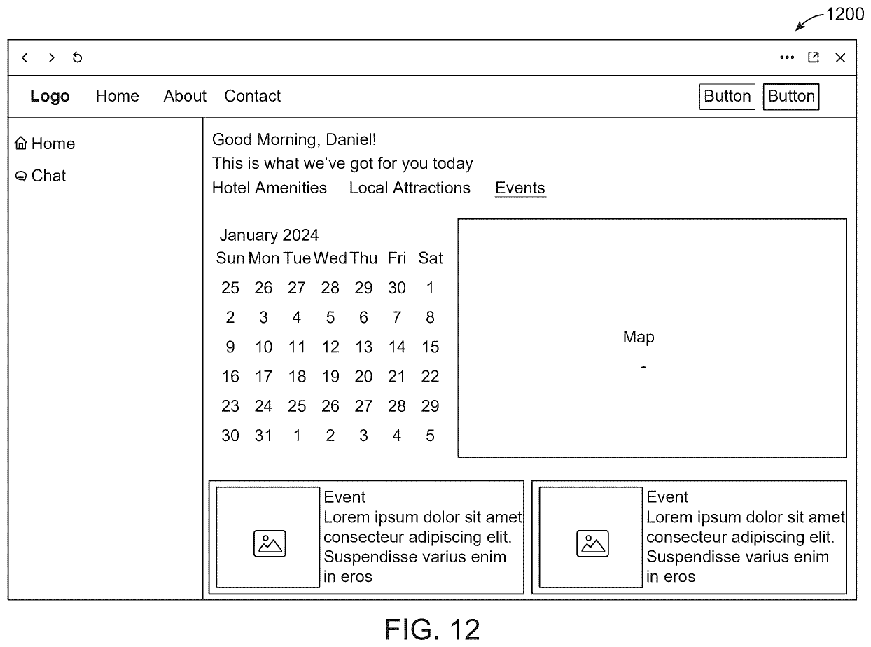

FIG. 12 exemplarily illustrates a screenshot of a user interface displaying information related to nearby events to the first user, according to an embodiment of the present invention.

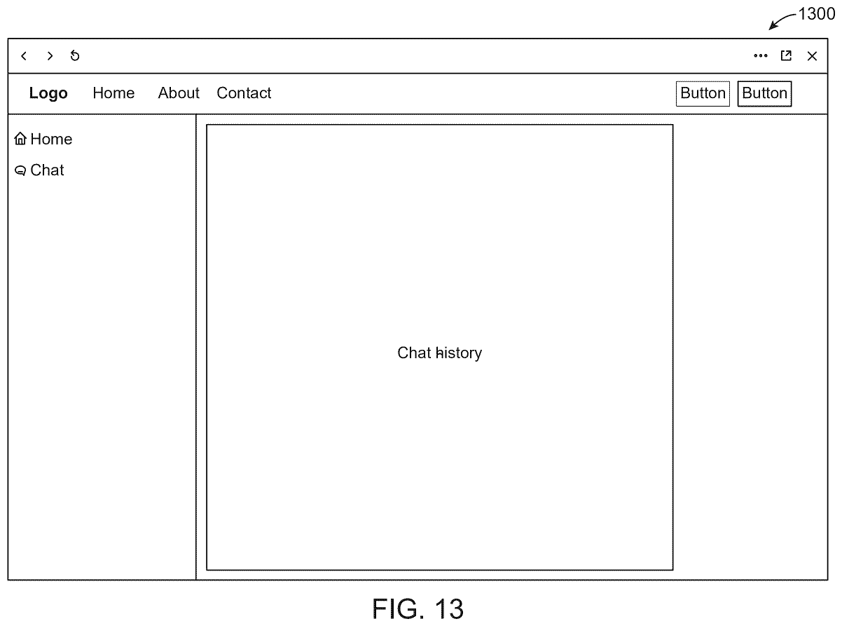

FIG. 13 exemplarily illustrates another screenshot of a user interface displaying the chat history of the first user and the second user, according to an embodiment of the present invention.

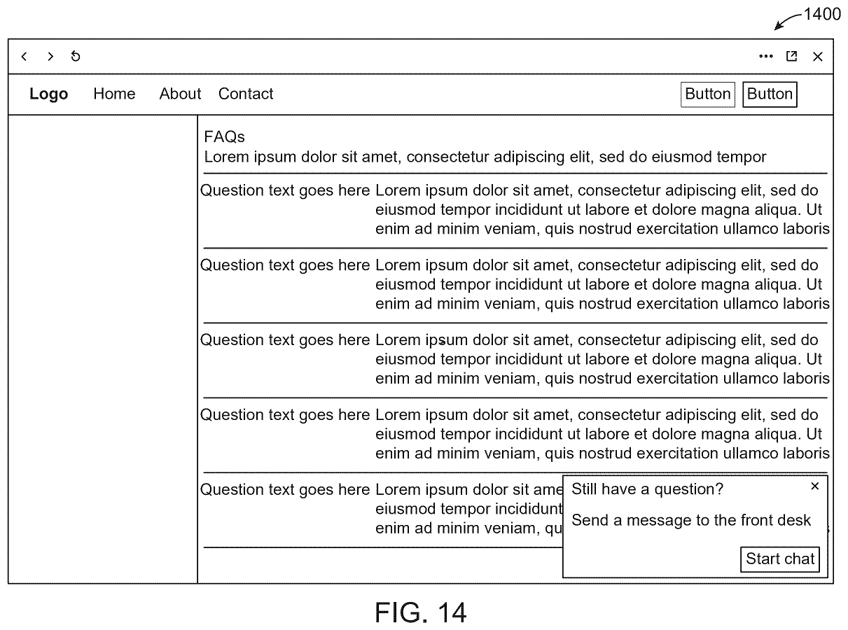

FIG. 14 exemplarily illustrates a screenshot of a user interface displaying information related to frequently asked questions, according to an embodiment of the present invention.

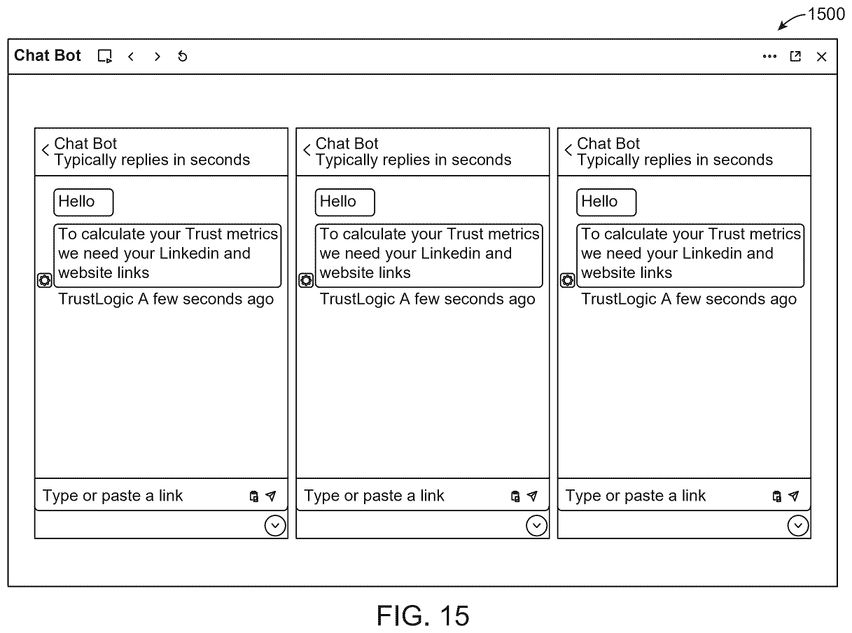

FIG. 15 exemplarily illustrates a screenshot of a user interface of a chatbot assisting the first user, according to an embodiment of the present invention.

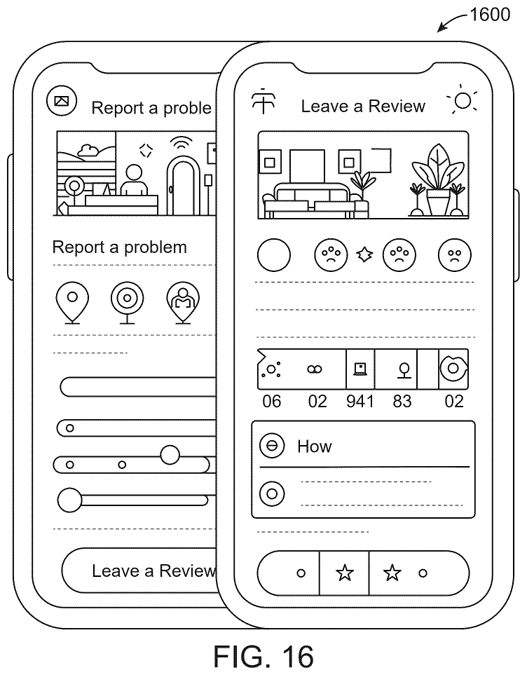

FIG. 16 exemplarily illustrates a screenshot of a user interface to provide feedback by the first user regarding the hotel accommodation, according to an embodiment of the present invention.

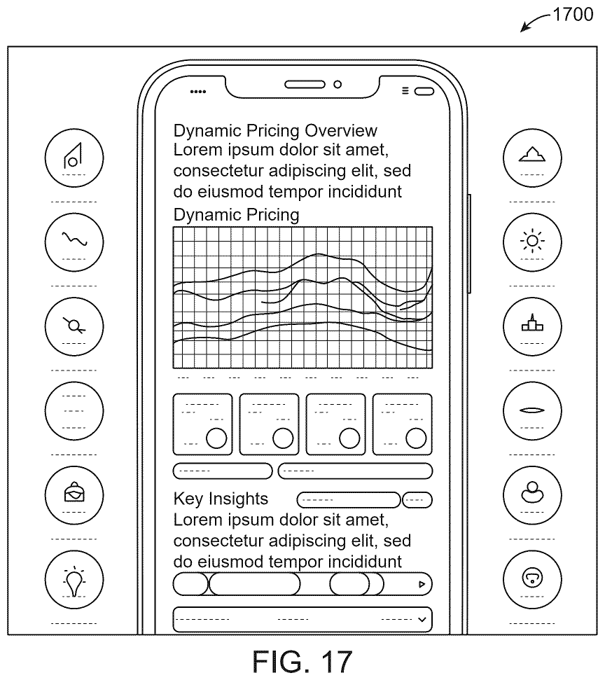

FIG. 17 exemplarily illustrates a screenshot of a user interface displaying overview of dynamic pricing of hotel accommodations, according to an embodiment of the present invention.

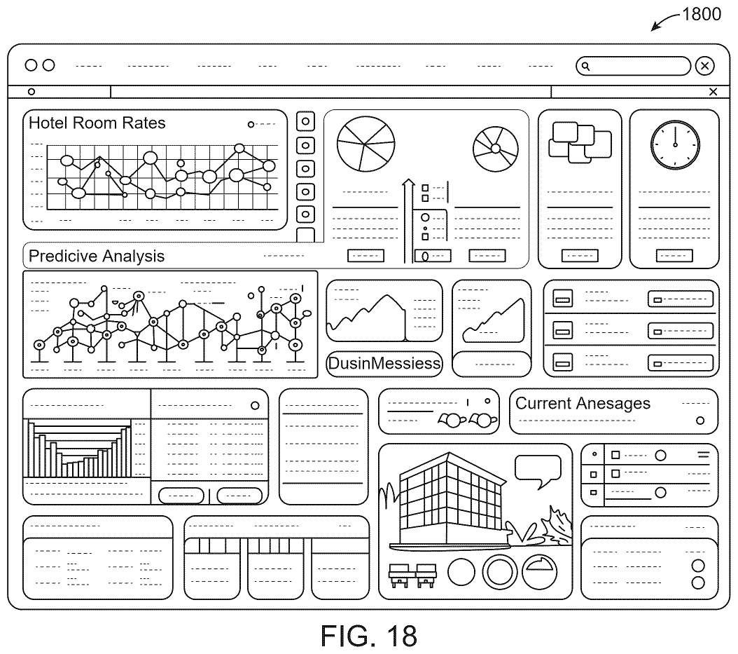

FIG. 18 exemplarily illustrates a screenshot of a user interface of a dashboard displaying information related to hotel accommodations, according to an embodiment of the present invention.

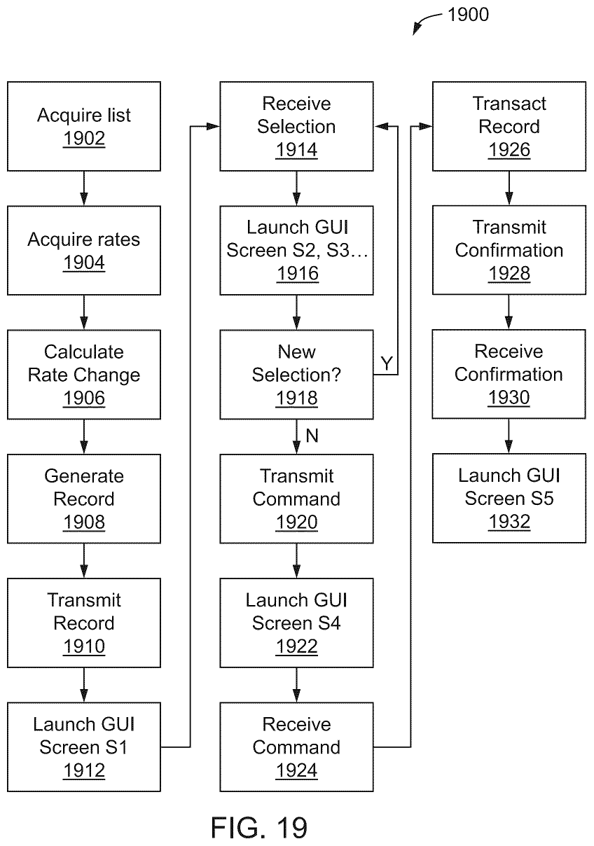

FIG. 19 exemplarily illustrates a flowchart of a method for artificial intelligent based hotel management, according to an embodiment of the present invention.

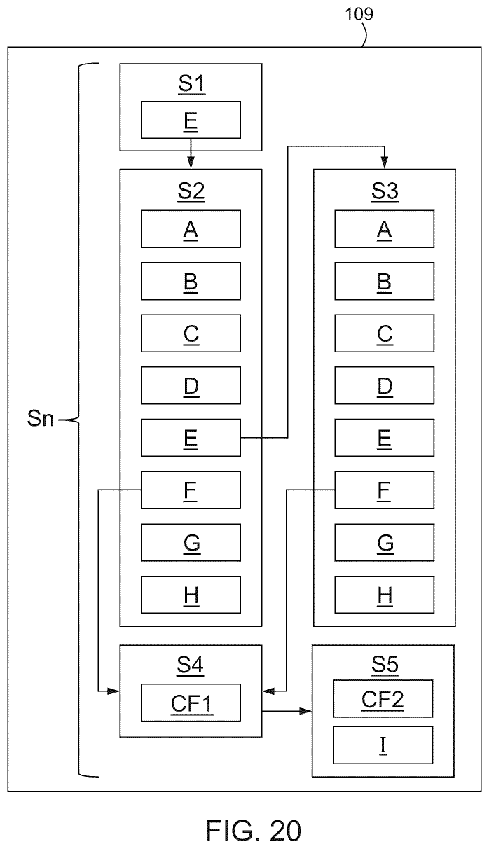

FIG. 20 exemplarily illustrates a sequence of GUI screens for artificial intelligent based hotel management, according to an embodiment of the present invention.

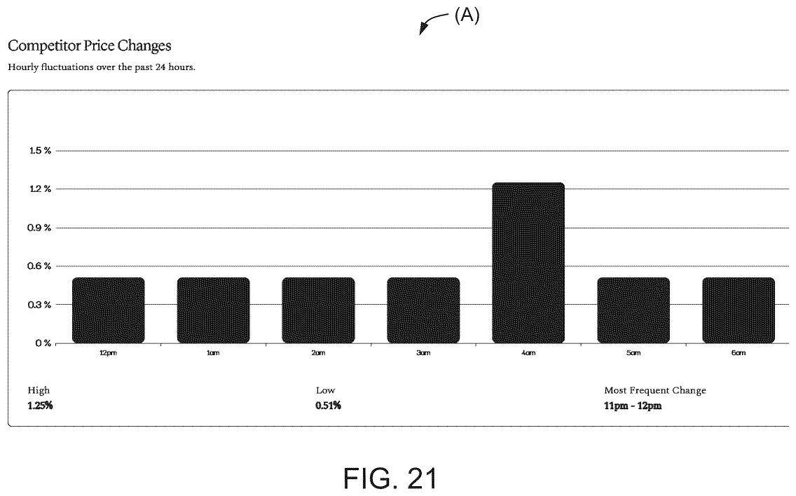

FIGS. 21-23 exemplarily illustrate GUI screen elements for artificial intelligent based hotel management, according to an embodiment of the present invention.

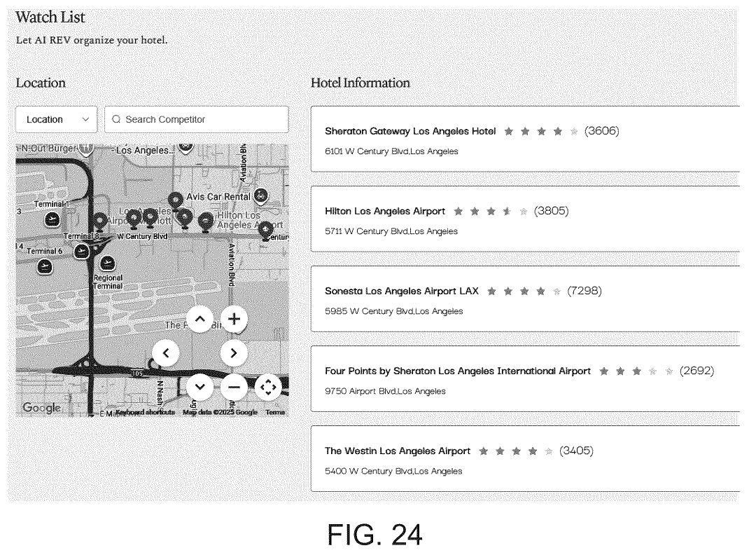

FIG. 24 exemplarily illustrates information regarding amenity providers for artificial intelligent based hotel management, according to an embodiment of the present invention.

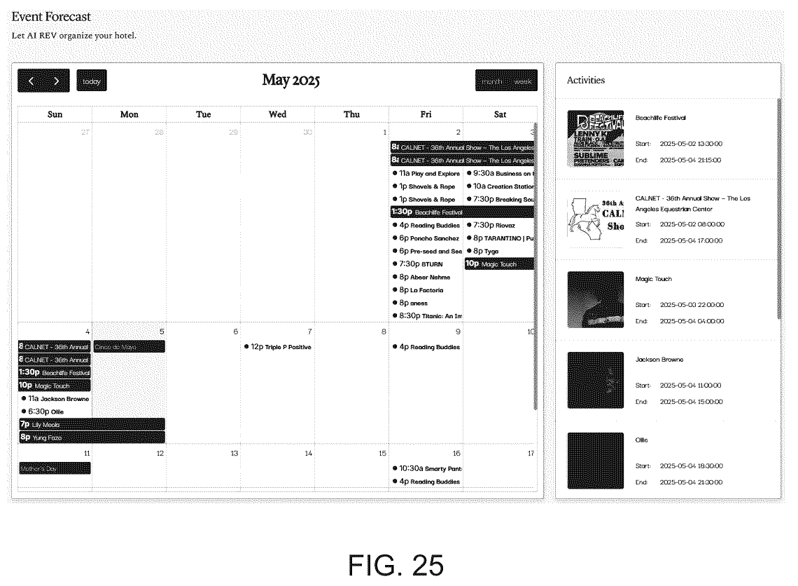

FIG. 25 exemplarily illustrates information regarding local events for artificial intelligent based hotel management, according to an embodiment of the present invention.

### DETAILED DESCRIPTION

Referring now to the present invention in more detail, AI-based hotel management system or AIOSHI (AI All in One Solution for the Hospitality Industry) that integrates AI technology into hotel management and guest services is described herein.

Referring to FIG. 1, the artificial intelligent based hotel management system 100 of comprises a server 102 in communication with a database 104. The system further comprises a first user device 106 and a second user device 108. The first user device 106 and the second user device 108 are in communication with the server 102 via a network 110. As discussed further below, for purposes of illustrating examples and in no way limiting the scope of the present invention, the first user may be a customer; the second user may be a staff responsible for managing hotel operations.

The server 102 could be any suitable server(s) for storing information, data, programs, and/or any other suitable content. In an example, the server 102 is at least one of a general or special purpose computer. The server 102 operates as a single computer, which could be a computing device, a workstation, a mainframe, a supercomputer, a server farm, and so forth. Although the server 102 is illustrated as a single device, the functions performed by the server 102 could be performed using any suitable number of computing devices. The server 102 further comprises an artificial intelligence module 112 for hotel management and a graphical user interface (GUI) server 111 for generating and implementing one or more GUIs and associated screens Sn to the client devices 106, 108 as described in detail in other sections.

The first user device 106, for example, includes, but not limited to, a desktop computer, a laptop computer, a mobile phone, a personal digital assistant, a tablet computer and/or any other suitable type of computer. The first user device 106 is associated with a first user. In an example, the first user is a user interested in accessing hotel amenities, making reservations, and exploring local attractions, and a user staying at the hotel or accommodation who seek information, assistance, and services during their stay.

The second user device 108, for example, includes, but not limited to, a desktop computer, a laptop computer, a mobile phone, a personal digital assistant, a tablet computer and/or any other suitable type of computer. The second user device 108 is associated with a second user. In an example, the second user is a staff or administrator responsible for managing hotel operations, including revenue management, customer service, and marketing and an administrator overseeing the centralized platform for monitoring hotel performance, setting prices, and generating reports.

The database 104 is accessible by the server 102. In an example, the database 104 resides in the server 102. In another example, the database 104 resides separately from the server 102. Regardless of location, the database 104 comprises a memory to store and organize data for use by the server 102. The database 104 comprises information related to the first user and the second user and information required for hotel management.

The network 110 generally represents one or more interconnected networks, over which the server 102, the first user device 106, and the second user device 108 could communicate with each other. The network 110 may include packet-based wide area networks (such as the Internet), local area networks (LAN), private networks, wireless networks, satellite networks, cellular networks, paging networks, and the like. A person skilled in the art will recognize that the network 110 may also be a combination of more than one type of network. For example, the network 110 is a combination of a LAN and the Internet. In addition, the network 110 is implemented as a wired network, a wireless network or a combination thereof.

The server 102 comprises at least one processor and at least one memory. The memory comprises a set of program modules executed by the processor. The server 102 is configured to enable the first user to input search criteria for a search related to hotel accommodation. In an embodiment, the input search criteria include a preferred location of the hotel, date range, price range, accommodation type, amenities, star ratings, guest ratings, specific hotel brand preferences and special offers and deals. The server 102 is further configured to display one or more hotels based on the input search criteria. The server 102 further facilitates marking one or more hotels as a preferred accommodation and set preferred price range to receive alerts. For example, the first user might want to be notified if the price increases or decreases by a certain percentage or amount. The server 102 further utilizes the web crawler 112A to scan event sites E1, E2. . . . En (individually and collectively En) to gather and provide information regarding events in a location proximal to the hotel booked by the first user. The server 102 further facilitates specifying a time frame for which the first user wants to receive updates about upcoming events. In addition, and as described herein, the system 100 may use the acquired event data when determining one or more recommended amenity rate changes (e.g., overnight room rate changes).

The server 102 further integrates with booking sources and monitors information related to the booking sources. In an example, the booking source is a third-party accommodation booking platform. The server 102 further monitors prices of hotel accommodation at the booking sources. The server 102 is configured to utilize predictive analysis for providing dynamic pricing of hotel accommodation based on the price range of booking sources. The server 102 is further configured to automatically update to display real-time hotel prices, including parent hotel rates.

The server 102 is further configured to connect with various Application Programming Interfaces (APIs) and enable the hotel management system to seamlessly integrate with external services and platforms to enhance operational efficiency and guest satisfaction. The server 102 connects with API and enables hotel operation management, revenue management and guest review management. The server 102 is configured to ensure that room availability and rates are synchronized in real-time to reduce the risk of overbooking and streamline the booking process for guests and allow hotels to monitor and manage guest feedback effectively. The server 102 is further configured to collect information related to the first user and create a first user profile. The server 102 is configured to collect contact information, address details, booking history including dates, room types, and booking channels, and residential or mailing address, including city, state, postal code, and country. The server 102 is configured to aggregate first user profiles into a centralized dataset.

The server 102 is further configured to generate reports and forecasts for hotel revenue and business analytics. The reports include, but are not limited to, revenue report, occupancy report, forecast report and business analytics report, ADR (Average Daily Rate) reports, and Revenue Per Available Room (RevPAR) reports. In an embodiment, the server 102 is configured to provide report in format that could be easily understandable by the reader. The server 102 is further configured to provide a dashboard interface for responding to messages and reviews of the first user. The server 102 further integrates with external review platforms, for example, TripAdvisor and Google Reviews, to analyse and report on guest feedback trends.

The AI-based hotel management system may offer a dual interface, catering to both management and guests. For management, the AI-based system may be configured to receive data on hotel occupancy, Average Daily Rate (ADR), Revenue Per Available Room (RevPAR), comparative statistics for relevant competitors of the hotel, and current conditions (i.e., such as weather, scheduled events, etc.), in order to optimize room rates and generally provide real-time data on hotel performance, competitor rates, and local events, facilitating proactive revenue or RevPAR optimization and management in seamless integration with other existing booking platforms.

This may be achieved by way of an AI module that may be adapted for training via an accelerator module of the AI to which existing historical data (for example and without limitation STR reports or the like) may be provided. For example, and without limiting the scope of the present invention, a report such as a STR report may include a number of useful data points that can be used to train the AI. These data points may include, by way of example and without limiting the scope of the present invention in any way: weekly performance for a hotel and the hotel competitors; occupancy data-including occupancy rates for the target property in comparison to competitors, as well as index (MPI) information regarding occupancy; ADR data-including ADR values for the target property in comparison to competitors, as well as index (ARI) information regarding ADR; RevPAR data-including RevPAR values for the target property in comparison to competitors, as well as index (RGI) information regarding RevPAR; or any other data point that may be tracked daily, weekly, per a predetermined number of days (e.g., 28 days), monthly, or in any other manner. These various data points may be further categorized-for example, and without limitations-by types of customers, such as transient customers, group customers, contract-based customers, or any other categorization scheme that may be reasonably employed in the hotel industry.

Additionally, the AI module may employ an algorithm whereby the AI-based system deploys one or more crawlers throughout the Internet to retrieve current real-time information from numerous sources-including but not limited to real-time or approximate real-time hotel room pricing information of competitors CPn, weather reports, flight delays, scheduled events like sports games or concerts from event sites En-in order for the AI-based system to incorporate into its analysis.

For guests-and more importantly assistance to management in handling certain guest requests, guest profiles may be centralized, and communication streamlined through automated responses and analysis of guest reviews via machine learning algorithms. By automating routine tasks and enhancing guest experience, the system addresses diverse needs in the hospitality industry, thereby improving efficiency and service quality.

In some exemplary embodiments, and without limiting the scope of the present invention, an AI-based algorithm may crawl OTA websites to read guests reviews, draft and/or send reply notes, and or post on or in response to these reviews automatically and in real time with accurate, good quality language to enhance guests' experiences. For example, and without limiting the scope of the present invention, in some embodiments of Artificial Intelligence Module (AI module 112), AI module 112A may employ a web crawler algorithm-such as a spider or spiderbot configured to systematically browse network 110 (for example, the Internet)-with a focus on online travel agency websites, such as OTA1, OTA2, . . . OTAn (individually and collectively OTAn) in order to locate and address information inquiries or comments or feedback regarding the establishment managed by server 102 of system 100.

In exemplary embodiments, as shown in FIG. 1 and as discussed with reference to FIG. 2 below, AI module 112A may be configured to monitor sites like express, kayak, hopper, booking.com, Expedia, other OTAn websites, other affiliate or aggregate booking sites, and/or competing online hospitality-amenity providers CP1, CP2, . . . . CPn (individually and collectively CPn) to aggregate and analyze pricing data to determine optimal room rates at any given time. In turn, system 100 may be configured to combine all information gathered by AI module 112A, including pre-set preferences and goals for business revenue, to create price proposals for any given room at any given data in real-time, while considering real-time market conditions and business objectives.

The system facilitates these functionalities seamlessly, ensuring a smooth and efficient experience for hotel guests. According to the present invention, a QR code is provided at the hotel room, and upon scanning the QR code, guests are seamlessly directed to the AI-powered concierge chat interface, where they could access a wide array of services and information. The system responds to guest queries about hotel amenities, provides recommendations, and facilitates communication with the front desk through text messaging. Leveraging advanced machine learning algorithms, the system comprehensively analyses relevant data from the hotel's website and external sources to offer tailored suggestions and insights. Furthermore, it seamlessly integrates with third-party online travel agencies for convenient room bookings. Overall, the system enhances guest satisfaction by offering personalized assistance and valuable insights throughout their stay.

Referring to FIG. 2, at step 202, a method 200 of artificial intelligence-based hotel management is executed in the system comprising the server 102 in communication with the database 104. The system further comprises the first user device 106 and the second user device 108. The first user device 106 and the second user device 108 are in communication with the server 102 via the network 110.

At step 204 to step 216, the system enables room pricing management and revenue management.

At step 206, the system is configured to view and monitor the process of neighbouring hotels and competitor hotels to adjust the prices being displayed in the system of the present invention to maintain competitiveness without compromising profitability.

At step 208, the system considers price of different types of hotels, including, but not limited to, low end hotel, medium business class, Luxury hotel, high end luxury. At step 210, the system is further configured to continuously track factors that affect prices range of hotel accommodation. The factors include, but are not limited to, concerts, events, sports, festivals, conventions, airline delays, airline cancellations, weather, natural disasters, political issues, controversies, holidays (i.e., for example, weekends, school breaks such as spring break, Christmas, Valentines, Thanskgiving, Mothers' Day or Fathers' Day), or any other factor that may be utilized to continuously track factors that affect prices range of hotel accommodations.

At step 212, the system further views and monitors platforms, for example, express, kayak, hopper, booking.com, Expedia, OTA websites, and other affiliate or aggregate booking sites to aggregate and analyze pricing data to determine optimal room rates at any given time. In exemplary embodiments, this step may include one or more routines or subroutines (B). For example, and without limiting the scope of the present invention, routines (B) may include steps 227 through 229 discussed below, which may invoke or employ use of a web crawler or spider component.

At step 214, the system is configured to combine all information from steps 206 to 212, including pre-set preferences and goals for business revenue, to create price proposals for any given room at any given data in real-time, while considering real-time market conditions and business objectives.

At step 216, the system displays key pricing information for easy interpretation by management staff via a clear and intuitive user interface (also referred to as a graphical user interface or GUI).

At step 218, the system provides AI concierge. At step 220, the system provides a customer or guest interface (also referred to as a graphical user interface or GUI), accessible via both mobile devices and web browsers, which prioritizes ease of access, particularly during the check-in procedure. A key feature integrated into the interface is the ability for guests to conveniently scan a QR code assigned to their room. Upon scanning, the system promptly retrieves and presents all relevant information pertaining to the room. The information includes details such as room amenities, booking specifics, and any additional instructions or services available to the guest.

At step 222, the system provides ChatGPT or LLM based conversational chat interface to address fundamental inquiries and accommodate hotel-related requests. The interface possesses the capability to process requests, such as “please refill soap & towels,” and promptly relay them to the hotel staff in real-time.

At step 224, the system facilitates making reservations, recommend tourism locations and give suggestions for fun vacation. At step 226, the system aggregates all guest feedback data across various platforms and formulates responses prioritizing customer service excellence.

As mentioned above, step 227 may be a routine or subroutine triggered independently or as a component of the processes discussed with reference to step 212. In exemplary embodiments, viewing or monitoring the Hotel Website may be achieved with a crawler or spider controlled by AI module 112A. AI module 112A may further crawl through external websites, such as those mentioned above, to identify and respond to any or all or a subset of basic questions, comments, feedback, or other user-generated inputs on those sites. Optionally, although not necessarily, a step 230 may be employed whereby this information may be gathered and provided to server 100 as in step 214 in order to combine with the other data points and make determinations as discussed above with reference to step 214.

At step 228, a similar algorithm may be invoked or employed, although without requiring external crawling. For example, and without limiting the scope of the present invention, a chat interface may be deployed internally on the Hotel website only. In this step, the chat interface may assign and or handle requests to and from guests of the Hotel, and or to and from a Front Desk of the Hotel. Optionally, although not necessarily, step 230 may be employed whereby this information may be gathered and provided to server 100 as in step 214 in order to combine with the other data points and make determinations as discussed above with reference to step 214.

At step 229, a subroutine or routine may be initiated (in conjunction with or as a result of or independently from step 224) whereby in the course of the processes described in step 224, a similar algorithm may be invoked or employed, in order to message the Front Desk and or respond-for example and without limiting the scope of the present invention-as an intermediary from Guest to Front Desk and vice versa. Optionally, although not necessarily, step 230 may be employed whereby this information may be gathered and provided to server 100 as in step 214 in order to combine with the other data points and make determinations as discussed above with reference to step 214.

Turning now to the next figure. FIG. 2A exemplarily illustrates two methods for autonomously accessing, reviewing, and responding to reviews and chat inquiries automatically, or optionally, automatically preparing each response for admin approval. Moreover, the AI is preferably adapted to increasingly improve auto responses to each review or chat inquiry by access to prior reviews and chats, as well as templates.

By way of example, and in no way limiting the scope of the present invention. FIG. 2A illustrates method 200A, which is a method whereby the AI system utilizes ML, templates, and access to hundreds of reviews to learn and provide useful, real responses that are “mindful” or responsive to each review's syntax, context, and or emotion.

At step 231A, the system may access real reviews or real-time feedback or comments from users. The system may further access, at step 232A, a database of template responses to a wide variety of categories, types, or samples of reviews. At step 233A, real, prior reviews may also be accessed by the system. At step 234A, the system may employ machine learning and or a suitable AI algorithm suitable for or adapted to learn what best template, and or prior real response may be suitable for implementing a response to the real review or real-time feedback or comment retrieved in step 231A. At step 235A, an output may be generated, whereby the output response to the review retrieved in step 231A is provided. In some exemplary embodiments, the output is provided autonomously and automatically. In other exemplary embodiments, the output is optionally provided to an admin personnel for approval prior to being posted. Accordingly, method 200A employs ML, templates, and access to hundreds of reviews to learn and provide useful, real responses that are “mindful” or responsive to each review's syntax, context, and or emotion.

Similarly, also way of example and in no way limiting the scope of the present invention, FIG. 2A also illustrates method 200B, which mirrors 200A but addresses chat inquiries from guests. As with the reviews, the AI system utilizes ML, templates, and access to hundreds of real-time responses to inquiries, in order to learn and provide useful, real responses that are “mindful” or responsive to each inquiries' syntax, context, and or emotion.

At step 231B, the system may access real-time chat inquiries from users. The system may further access, at step 232B, a database of template responses to a wide variety of categories, types, or samples of chat inquiries. At step 233B, real, prior responses to chat inquiries may also be accessed by the system. At step 234B, the system may employ machine learning and or a suitable AI algorithm suitable for or adapted to learn what best template, and or prior real response may be suitable for implementing a response to the real chat inquiry retrieved in step 231B. At step 235B, an output may be generated, whereby the output response to the chat inquiry retrieved in step 231B is provided. In exemplary embodiments, the output is provided autonomously and automatically.

FIG. 3 exemplarily illustrates a screenshot 300 of a user interface for monitoring price data, according to an embodiment of the present invention. The user interface generates a report for monitoring price data. FIG. 4 exemplarily illustrates a screenshot 400 of a user interface for monitoring dynamic price data, according to an embodiment of the present invention. The user interface generates a report for monitoring dynamic price data. FIG. 5 exemplarily illustrates a screenshot 500 of a user interface displaying a list of events, according to an embodiment of the present invention. The user interface displays the list of events at locations preferred by the first user. FIG. 6 exemplarily illustrates a screenshot 600 of a user interface displaying dynamic pricing based on hotels near a predefined location using predictive analysis, according to an embodiment of the present invention.

FIG. 7 exemplarily illustrates a screenshot 700 of a user interface displaying first user profiles, according to an embodiment of the present invention. Each profile comprises information including, but not limited to, full name of the first user, email address, phone numbers and details regarding the booking of accommodation. As may be appreciated from this figure, a variety of functions are exemplarily illustrated, including the use of TAGS. These TAGS may allow a management user to categorize different types of customers-for example and in no way limiting the scope of the present invention, TAGS may be assigned to Transient customers, Group customers, Contract customers, or the like. Similarly, other tags may be used for categorizing purposes. When employing the AI, the AI may use these tags to provide useful feedback. FIG. 8 exemplarily illustrates a screenshot 800 of a user interface displaying notifications, according to an embodiment of the present invention. The alerts and notifications are predefined by the first user and the second user.

FIG. 9 exemplarily illustrates a screenshot 900 of a user interface displaying a request of a first user, according to an embodiment of the present invention. The user interface displays the request of the first user, for example, guest, to the second user, for example, hotel administrator. FIG. 10 exemplarily illustrates a screenshot 1000 of a user interface displaying the chat history of the first user and the second user, according to an embodiment of the present invention. FIG. 11 exemplarily illustrates a screenshot 1100 of a user interface displaying information related to hotel accommodation to the first user, according to an embodiment of the present invention. The information includes, but not limited to, hotel amenities, room features, dining options, nearby attractions, local transportation options, and special events or promotions.

FIG. 12 exemplarily illustrates a screenshot 1200 of a user interface displaying information related to nearby events to the first user, according to an embodiment of the present invention. FIG. 13 exemplarily illustrates another screenshot 1300 of a user interface displaying the chat history of the first user and the second user, according to an embodiment of the present invention. FIG. 14 exemplarily illustrates a screenshot 1400 of a user interface displaying information related to frequently asked questions, according to an embodiment of the present invention. FIG. 15 exemplarily illustrates a screenshot 1500 of a user interface of chatbot assisting the first user, according to an embodiment of the present invention.

FIG. 16 exemplarily illustrates a screenshot 1600 of a user interface to provide feedback by the first user regarding the hotel accommodation, according to an embodiment of the present invention. FIG. 17 exemplarily illustrates a screenshot 1700 of a user interface displaying an overview of dynamic pricing of hotel accommodations, according to an embodiment of the present invention. The interface, as per an embodiment of the present invention, displays real-time adjustments in room rates based on various factors such as demand, availability, and competitor pricing.

FIG. 18 exemplarily illustrates a screenshot 1800 of a user interface of a dashboard displaying information related to hotel accommodations, according to an embodiment of the present invention. The dashboard presents key metrics, including, but not limited to, occupancy rates, revenue forecasts, and guest feedback summaries, enabling efficient management and decision-making for hotel operations.

Advantageously, the present invention is designed as a comprehensive, all-in-one solution catering to both management and guest needs within the hotel industry. The user interface (UI) on the management side prioritizes aesthetics, simplicity, and ease of navigation, while displaying real-time data and intuitive dashboards. Upon logging in, management is greeted with a page featuring their hotel and essential property information, including current occupancy rates. Additionally, the system allows for monitoring competitor hotels and their real-time rates and offers suggestions for rate adjustments. A calendar of nearby events, powered by AI, provides valuable insights. The system also includes revenue management, automated report generation, and marketing material distribution. Furthermore, a dedicated dashboard displays information about current guests and their preferences.

For guests accessing the system via QR code or the website, an AI concierge chatbot is presented, capable of offering personalized suggestions and addressing requests using machine learning algorithms. The AI concierge intelligently identifies the guest's exact hotel, either through a unique QR code or location data, and leverages information from the hotel's website to answer basic inquiries such as breakfast timings and checkout procedures. By integrating these functionalities, the system aids management in efficiently monitoring rates and competitors while continuously learning and adapting to the hotel's environment and guest feedback.

Moreover, for guests, the AI concierge significantly streamlines interactions by automatically handling routine inquiries, thereby reducing front desk workload. In case of room issues, guests can simply relay their concerns through the chatbot, facilitating swift resolution by the front desk. The integrated method enhances guest experience and also improves operational efficiency for hotel management.

Returning to FIG. 1, the first and second user devices 106, 108 (also referred to herein as client devices) may each receive and implement (e.g., from the server 102, e.g., the GUI server 111) one or more graphical user interfaces (GUIs). For example, the first device 106 may receive and implement a first GUI 107 and the second device 108 may receive and implement a second GUI 109. In some embodiments, the first GUI 107 may be configured to implement and launch one or more screens Sn (also referred to as displays, windows, pop-ups, etc.), and the second GUI 109 may be configured to implement and launch one or more screens Sn (also referred to as displays, windows, pop-ups, etc.). In some embodiments, all, most, or some of the one or more screens Sn implemented by the second client device 108 may be different from the one or more screens Sn implemented by the first device 106, given that the second client device 108 may be utilized by the in-house hospitality administrators and the first client device 106 may be utilized by patrons of the in-house amenity provider (e.g., hotel guests). For example, as described herein, the screens Sn implemented by the second client device 108 may provide specific tools to the administrator to manage, optimize, and generally streamline the in-house amenity services and associated metrics (e.g., overnight stay rate, room occupancy and availability, etc.).

Additional embodiments and details of the system 100 will next be described by way of several detailed examples. The examples provided below are chosen to illustrate various embodiments and implementations of the system 100, and those of ordinary skill in the art will appreciate and understand, upon reading this description, that the examples are not limiting and that the system 100 may be used in different ways. It is also understood that details of different embodiments described in different examples may be combined in any way to form additional embodiments that are all within the scope of the system 100.

For the purpose of this specification, an amenity provider utilizing the system 100 will be referred to as the parent amenity provider, parent hospitality provider, or the in-house amenity provider, or similar, and the services and metrics associated with the parent amenity provider will be referred to as the parent provider metrics or the in-house metrics (e.g., in-house amenity rate) or similar. Additionally, while this specification may in some instances describe the system's functionalities with respect to gathering information from competing online amenity providers (e.g., competing hotels in the area), it is understood that this also may include gathering pertinent information from other sources described herein, such as, but not limited to, OTAn websites, other affiliate and/or aggregate booking sites, and/or other suitable sources.

In some embodiments, as shown in FIG. 19, the system 100 may perform some, and preferably all, of the actions 1900.

In some embodiments, the system 100, at 1902, may acquire or otherwise receive a list of other hospitality amenity providers (e.g., competing hotels in the area). For example, the system 100 may utilize a network crawler 112A (also referred to as a web crawler) to crawl the network 110 (e.g., the Internet) and identify competing amenity providers, e.g., in the local area of the parent hospitality provider implementing the system 100 (e.g., within 10 miles of the parent provider). In another example, the list of competing amenity provides may be uploaded or otherwise provided to the system 100.

In some embodiments, at 1904, the system 100 may then acquire or otherwise receive the amenity rates (preferably real time or pseudo real time) offered by each of the competing amenity providers on the list. For example, the system 100 may utilize a web crawler 112A to scan and/or index information from the websites and/or other dialogues or interfaces of the competing amenity providers to determine the providers' real time amenity rates (e.g., the overnight stay rates of the hotels). In some embodiments, because the competitor amenity rates may change frequently, the system 100 may perform this process on a schedule, e.g., at predetermined intervals such as every hour throughout each day. Other time intervals also may be used, and the intervals need not match (but it may be preferable that they do). In this way, the system 100 may obtain the rates of each competing provider multiple times a day throughout each day to record the change in the competing rates accordingly. In some embodiments, the system 100 also may obtain, via this process, other metrics of the competing providers such as, but not limited to, occupancy rates, room availability rates, overall amenity provider ratings (e.g., customer ratings, industry ratings, etc.), etc. This information may then be stored in the system database 104.

At 1906, the system 100 may then calculate the change in each of the competing providers at each time interval. For example, if the system 100 performs the network crawling every hour on the hour, the system 100 may calculate the rate change amount at each hour of the day (e.g., by comparing a real-time rate to a rate acquired an hour prior) for each competing provider. This may be a percentage change, an absolute change, a proportional change, and/or other measurement type of change. In this way, the system 100 may record each rate change of each competing amenity provider throughout each day.

At 1908, the system 100 may analyze the competing providers' amenity rates, the changes in the competing providers' amenity rates at each time interval, and other information such as the competitors' occupancy rates and/or amenity availability rates (all of which may be referred to as the competing amenity rates information), as well as the corresponding metrics of the parent provider, to generate an amenity rate change record, wherein the amenity rate change record includes, at least some of (and preferably all of), the acquired competitor amenity rates, the corresponding calculated competitor amenity rate changes, a statistical comparison of the acquired amenity rates and a current in-house amenity rate (e.g., at each time interval), and a proposed in-house amenity rate (e.g., a proposed change to the current in-house amenity rate).

In some embodiments, the system 100 may perform various statistical analyses of the competing amenity rate information (including the current in-house amenity rates where appropriate) in order to compare and/or otherwise assess the competing rate information with respect to the current in-house amenity rate(s) to generate the amenity rate change record (while determining a proposed in-house amenity rate). For example, in some embodiments, the system 100 may perform descriptive statistical analysis methods to calculate averages (or means), medians, and/or modes of the competing rate information. In another example, the system 100 may calculate the ranges, variances, standard deviations, and/or interquartile ranges (IQR) of the competing rates information. In another example, the system 100 may analyze the frequency distribution of the competing rates information using X-Y plots, histograms, bar charts, pie charts, and/or other associated types of analyses. The system 100 also may utilize cross-tabulations (e.g., contingency tables), inferential statistical analyses such as point estimations and/or interval estimations, confidence intervals (including margins of error), hypothesis testing such as null hypothesis (HO), alternative hypothesis (H1), and/or P-values. Regression analysis also may be used, e.g., simple linear regressions, multiple regressions, and/or logistic regressions.

In addition, in some embodiments, the system 100 may perform graphical analysis techniques such as scatter plots, box plots, stem-and-leaf plots, and/or other types of graphical techniques. The system 100 also may perform quantitative techniques such as summary statistics and/or correction analysis, as well as predictive analysis such as time series analysis, moving averages, exponential smoothing, and/or autoregressive integrated moving averages (ARIMA models).

Furthermore, in some embodiments, the system 100 may perform multivariate analyses such as factor analyses, principal component analyses (PCA), cluster analyses (e.g., K-means and/or hierarchical clustering), and/or Bayesian analyses (e.g., Markov Chain Monet Carlo (MCMC) analysis), and/or sampling methods such as a Metropolis-Hastings algorithm and/or Gibbs sampling. In addition, the system 100 may perform non-parametric methods such as rank-base tests (e.g., Mann-Whitney U tests and/or Kruskal-Wallis tests) and/or distribution-free methods such as bootstrapping and/or permutation tests. It is appreciated that the system 100 may perform any types of appropriate analyses on the competing rate information (and on the in-house information where appropriate) to generate the amenity rate change record (while determining an optimized proposed in-house amenity rate).

For example, when determining the proposed in-house amenity rate, using the information described above, the system 100 may determine that the parent provider's current amenity rate is below an average of the competing providers' rates at a particular date and time, and as such, in an effort to increase revenue for the parent provider, the system 100 may recommend that the parent provider increase their rate. Conversely, the system 100 may determine that the parent provider's rate is above the competitors' rates such that the system 100 may recommend lowering the parent's rate to capture more patrons.

In another example, if the system 100 determines that there is a shortage of available rooms for the particular time interval (e.g., determined from the competitors' occupancy rates and/or room availability), the system 100 may determine and recommend an increase in the parent amenity rate to take advantage of the low inventory of available amenities. In another example, if the system 100 determines an event to be taking place on a particular date (e.g., a sporting event, concert, etc.) such that the demand for amenities on that particular date may be high due to spectators traveling to the event from out of town, the system 100 may recommend an increase in the parent provider's rates on that date due to the event. This analysis and information and the resulting recommendations may be a basis for the in-house amenity rate change record.

In some embodiments, at 1910, the system 100 may transmit, over the network 102 and to the client device 108, the amenity rate change record, and at 1912, upon receiving the amenity rate change record, the client device 108 may execute the associated GUI 109. Upon executing the GUI 109, the client device 108 also may launch a first screen S1 within the GUI 109 on the client device 108 as shown in FIG. 20. In some embodiments, action 1910 may be triggered to occur when a user logs into the system 100, e.g., via the client device 108 and/or the GUI 109, that is, the user may log into the client device 108 via a log-in page which may trigger the execution of the GUI 109 and the transmission of the amenity rate change record to the client device 108 from the server 102 and the launch of the first screen S1 within the GUI 109.

In some embodiments, as shown in FIG. 20, the first screen S1 may comprise a user selection mechanism (E) (e.g., a dropdown menu on the touchscreen) displaying the list of competing amenity providers and enabling a user of the client device 108 to choose a competing online amenity provider from the list. Once a particular competing provider is chosen from the GUI element (E), the client device 108 may launch a second screen S2 within the GUI 109 (as shown in FIG. 20) comprising at least some of (and preferably all of) the following GUI screen elements:

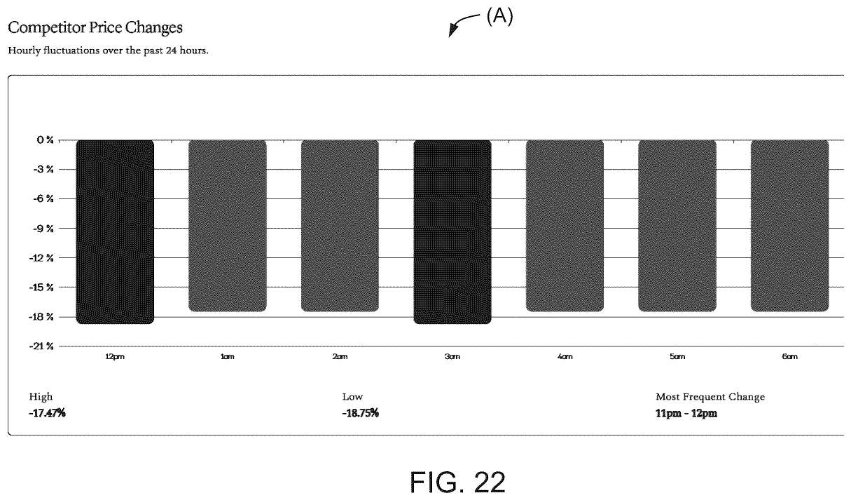

(A) A graphical representation of each calculated amenity rate change of the competing amenity provider chosen by the user using the first screen S1, the calculated amenity rate change of the competing provider displayed according to each predetermined time interval (e.g., in a graph as shown in FIGS. 21 and 22, described in more detail below),

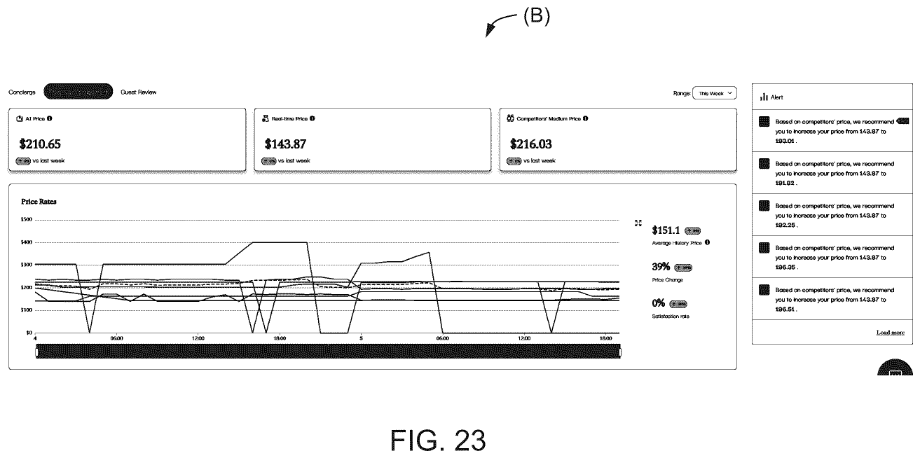

(B) A graphical representation of the acquired amenity rates (e.g., for all of the competing amenity providers in the list) and the proposed in-house amenity rate, the acquired amenity rates and the proposed in-house amenity rate displayed according to each predetermined time interval (e.g., in a graph as shown in FIG. 23, described in more detail below). In some embodiments, the graphical representation also may include the current in-house amenity rate(s) in the comparison.

(C) A statistical comparison of the acquired amenity rates and the current in-house amenity rate (e.g., an average or other statistical calculation of the acquired competing amenity rates compared to the current in-house amenity rate and/or to the proposed in-house amenity rate) as shown in FIG. 23, described in more detail below,

(D) A proposed in-house amenity rate as shown in FIG. 23, described in more detail below,

(E) The user selection mechanism enabling the user of the client device to choose a different competing amenity provider from the list of competing amenity providers as shown in FIG. 20, and

(F) An execute button to transact the amenity rate change record as shown in FIG. 20.

Next, at 1918, if the user chooses a different competing amenity provider from the user selection mechanism (E) on the second screen S2, the client device 108 may launch a third screen S3 within the GUI 109 showing elements (A′)-(C′) in regard to the newly chosen different competing amenity provider, and elements (D)-(H) as shown in FIG. 20.

If however, the user does not choose a different competing provider from the user selection mechanism (E), and instead, presses the execute button (H) on the second screen S2 of the GUI 109 (or on the third screen S3 if it was served) the client device 108 may transmit, at 1920, over the network 102 to the server 102, a system command to transact the amenity rate change record. In addition, upon the pressing of the execute button (H) on the second screen S2 (or on the third screen S3 if it was served) as shown in FIG. 20, and at 1922 in FIG. 19, the client device 108 may launch a fourth screen S4 within the GUI 109 comprising a first confirmation CF1 (e.g., a field) that the system command to transact the amenity rate change record has been transmitted to the server 102.

Then, at 1924, the system 100 may receive the system command at the server 102 from the client device 108 via the network 102, and at 1926, the system 100 (e.g., the server 102) may transact the amenity rate change record thereby updating the current in-house amenity rate to match the proposed in-house amenity rate.

Once the amenity rate change record has been transacted and the current in-house amenity rate has been updated to match the proposed in-house amenity rate, the server 102 may transmit to the client device 108 via the network 110, at 1928, an amenity change confirmation record confirming the transaction of the amenity rate change record and the corresponding implementation of the proposed in-house amenity rate.

At 1930, the client device 108 may receive the amenity change confirmation record from the server 102, and at 1932, the client device 108 may launch a fifth screen S5 within the GUI 109 (as shown in FIG. 20) comprising a second confirmation CF2 (e.g., a field) that the amenity rate change record has been transacted and the proposed in-house amenity rate has been implemented.

In some embodiments, as shown in FIG. 20, the fifth screen S5 also may include a generate new record button (I), that when pressed by the user of the client device 108, may cause the client device 108 to transmit a system command to the server 102 via the network 110 to trigger the server 102 to generate a new amenity rate change record using any newly acquired competitor amenity rates (e.g., new rates acquired after the acquisition of the rates used for the first amenity rate change record), the corresponding calculated competitor amenity rate changes, a statistical comparison of the newly acquired amenity rates and the newly updated current in-house amenity rate (e.g., at each time interval), and a newly proposed in-house amenity rate (e.g., a proposed change to the current in-house amenity rate). This may cause the workflow 1900 to return to action 1904 and to begin again thereat. This may be beneficial to the user, especially if an amount of time has passed between the generation of the first amenity rate change record and its ultimate transaction (e.g., several hours to one or more days). In this way, the user may review the information provided by the new amenity rate change record displayed on the updated screens Sn of the GUI 111 on the client device 108 to quickly determine if another in-house amenity rate change may be warranted given the updated information.

In some embodiments, as shown in FIG. 20, the second screen S2 within the GUI 109 also may include one or both of the following GUI screen elements:

(G) A graphical representation of a comparison of a first predicted revenue model based on the current in-house amenity rate and a second predicted revenue model based on a proposed transaction of the amenity rate change record, and

(H) A graphical representation of a comparison of a first predicted occupancy rate based on the current in-house amenity rate and a second predicted occupancy rate based on a proposed transaction of the amenity rate change record.

It is appreciated that the system 100 may perform the above operations 1902-1908 continuously (e.g., per the predetermined schedule and/or time intervals) so that an administrator may simply log into the system 100 at any given hour of any given day and see the most recent competitive information and to transact any amenity rate change record(s) that may be available.

As described above and as shown in FIGS. 19-23, the system 100 and its method is directed to displaying various elements of an amenity rate change record via ordered screens within a graphical user interface (GUI) that provide a unique combination of object data for presenting the amenity rate change record in a manner that is useful to users of the system 100. During operation, the client device 108 launches a particularly ordered combination of screens Sn within the GUI that together provide a visual and functional representation of the amenity rate change record thereby transforming it into a tangible tool for users of the system 100.

Furthermore, because different competing amenity providers may update their amenity rates frequently and at different times throughout any given day, the tools described herein provided by the system 100 provide up-to-date information in real time continuously throughout each day, every day. As such, the system 100 enables the parent amenity provider to analyze its competitors around the clock and to implement very fast changes to its in-house rates at a speed not achievable using other techniques. Additional details of FIGS. 21-25 will be described next.

FIG. 21 shows an example GUI screen element (A) including a graphical representation of the calculated amenity rate changes of the chosen competing amenity provider (e.g., chosen using element (E) in screen S1) acquired and calculated on an hourly basis from 12:00pm to 6:00am. As shown in this example, the calculated amenity rate changes are all positive rate changes (e.g., amenity rate increases). Also listed is a maximum of the increases (the “High”), a minimum of the increases (the “Low”), and a timeframe of the most frequent changes. FIG. 22 shows similar information but with the calculated amenity rate changes all negative rate changes (e.g., amenity rate decreases). It is appreciated that positive rate changes and/or negative rate changes may be displayed together on one graph as applicable.

FIG. 23 shows an example GUI screen element (B) including a graphical representation of the acquired amenity rates (e.g., for all of the competing amenity providers in the list), the current in-house amenity rate, and the proposed in-house amenity rate acquired and displayed over a two-day period. Also shown is a median price of all of the competing providers, the current in-house amenity rate, the proposed in-house amenity rate, an average historical amenity rate, and comparisons of the various information with respect to the week prior.

FIG. 24 shows example results of the system 100 implementing the web crawler 112A to identify and scan competing amenity providers, and to present the resulting competing providers' information in an easy-to-understand format, e.g., on a map and in an adjacent listing. As described in other sections, this competing providers information also may be used when creating an amenity rate change record and/or determining the proposed in-house amenity rate.

FIG. 25 shows example results of the system 100 implementing the web crawler 112A to identify and scan local event sites En, and to present the resulting event information in an easy-to-understand format, e.g., on a calendar and in an adjacent listing. As described in other sections, this event information also may be used when creating an amenity rate change record and/or determining the proposed in-house amenity rate.

It is understood that any element and/or aspect of any embodiment of the system 100 or method may be combined with any other element and/or aspect of any other embodiment of the system 100 or method to form additional embodiments of the system 100 and method, all of which are within the scope of the system 100 and method.

The embodiments described herein are not intended to be exhaustive or to limit the present invention to the precise forms disclosed. Rather, the embodiments selected for description have been chosen to enable one skilled in the art to practice the present invention. It should be understood that various modifications, adaptations, and alternatives may be employed without departing from the spirit and scope of the present invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the present invention will come to mind to one skilled in the art to which this present invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

In the claims:

1. A method, performed by a server and a plurality of user devices, for displaying and transacting an amenity rate change record by way of a graphical user interface (GUI) distributed to the plurality of client devices, comprising:
acquiring a list of competing online amenity providers;
acquiring, by the server over a network using a network crawler, amenity rates corresponding to each of the competing online amenity providers, the amenity rates acquired successively at predetermined time intervals;
calculating, by the server, an amenity rate change of each successive acquired amenity rate of each corresponding competing online amenity rate provider at each predefined time interval;
generating, by the server, the amenity rate change record, the amenity rate change record including the acquired amenity rates, the calculated amenity rate changes, a statistical comparison of the acquired amenity rates, a current in-house amenity rate, and a proposed in-house amenity rate;
transmitting, by the server via the network, the amenity rate change record to a client device configured to execute the GUI, wherein the client device automatically launches a first screen within the GUI in response to receiving the amenity rate change record via a notification, the first screen within the GUI comprising:
a user selection mechanism enabling a user of the client device to choose a competing online amenity provider from the list of competing online amenity providers,
wherein the client device launches a second screen within the GUI in response to the user using the user selection mechanism to choose the competing online amenity provider, the second screen within the GUI comprising:
(A) a graphical representation of each calculated amenity rate change of the competing amenity provider chosen by the user, the calculated amenity rate change displayed according to each predetermined time interval,
(B) a graphical representation of the acquired amenity rates and the proposed in-house amenity rate, the acquired amenity rates and the proposed in-house amenity rate displayed according to each predetermined time interval,
(C) the statistical comparison of the acquired amenity rates;
(D) the current in-house amenity rate,
(E) the proposed in-house amenity rate,
(F) the user selection mechanism enabling the user of the client device to choose a different competing amenity provider from the list of competing amenity providers, and
(G) an execute button to transact the amenity rate change record;
wherein the client device launches a third screen within the GUI in response to the user using the user selection mechanism to choose the different competing amenity provider, the third screen within the GUI comprising (A)-(C) with regard to the different competing amenity provider and (D)-(G);
transmitting, by the client device to the server via the network, in response to the user of the client device pressing the execute button on the GUI, a system command to transact the amenity rate change record within the server, wherein the client device launches a fourth screen within the GUI in response to the user pressing the execute rate change button, the fourth screen within the GUI comprising:
a confirmation that the system command to transact the amenity rate change record has been transmitted to the server;
receiving from the client device, by the server via the network, the system command to transact the amenity rate change record within the server; and
transacting, by the server, the amenity rate change record, wherein the transacting the amenity rate change record changes the current in-house amenity rate to match the proposed in-house amenity rate.

2. The method of claim 1, further comprising:
transmitting to the client device, by the server via the network, a confirmation of the amenity rate change record transaction within the server, wherein the client device launches a fifth screen within the GUI in response to receiving the confirmation of the amenity rate change record transaction, the fifth screen within the GUI comprising:
a confirmation of the amenity rate change record transaction, and a generate new record button that when pressed causes the client device to transmit to the server via the network a system command to generate a new amenity rate change record within the server based on newly acquired amenity rates and including corresponding calculated newly acquired amenity rate changes, a statistical comparison of the newly acquired amenity rates, a new current in-house amenity rate, and a new proposed in-house amenity rate.

3. The method of claim 1, the second screen within the GUI further comprising:
a graphical representation of a comparison of a first predicted revenue based on the current in-house amenity rate and a second predicted revenue based on a proposed transaction of the amenity rate change record, and/or
a graphical representation of a comparison of a first predicted occupancy rate based on the current in-house amenity rate and a second predicted occupancy rate based on the proposed transaction of the amenity rate change record.

4. The method of claim 1 wherein the amenity rate is an overnight stay rate.

5. The method of claim 1 wherein the predefined time interval is one hour.

6. The method of claim 1 wherein the statistical comparison includes calculating an average, a median, a mode, and/or a standard deviation.

7. The method of claim 1 further comprising:
prior to acquiring the amenity rates corresponding to each of the competing online amenity providers, editing, by the user, the list of competing online amenity providers.

8. The method of claim 7 wherein the editing the list of competing online amenity providers includes adding an additional amenity provider to the list and/or removing an amenity provider from the list.

9. The method of claim 1 wherein the list of competing online amenity providers includes competing online amenity providers, each with a physical location within a chosen geographic area.

10. A method, performed by a server and a plurality of user devices, for displaying and transacting an amenity rate change record by way of a graphical user interface (GUI) distributed to the plurality of client devices, comprising:
acquiring a list of competing online amenity providers;
acquiring, by the server over a network using a network crawler, amenity rates corresponding to each of the competing online amenity providers, the amenity rates acquired successively at predetermined time intervals;
calculating, by the server, an amenity rate change of each successive acquired amenity rate of each corresponding competing online amenity rate provider at each predefined time interval;
generating, by the server, the amenity rate change record, the amenity rate change record including the acquired amenity rates, the calculated amenity rate changes, a statistical comparison of the acquired amenity rates, a current in-house amenity rate, and a proposed in-house amenity rate;
transmitting, by the server via the network, the amenity rate change record to a client device configured to execute the GUI, wherein the client device automatically launches a first screen within the GUI in response to receiving the amenity rate change record via a notification, the first screen within the GUI comprising:
(A) at least one graphical representation of at least one of:
(i) a calculated amenity rate change of at least one competing amenity provider from the list of competing online amenity providers; and
(ii) an acquired amenity rate of the at least one competing amenity provider from the list of competing online amenity providers and the proposed in-house amenity rate;
(B) the statistical comparison of the acquired amenity rates;
(C) the current in-house amenity rate;
(D) the proposed in-house amenity rate, and
(E) an execute button to transact the amenity rate change record;
transmitting, by the client device to the server via the network, in response to the user of the client device pressing the execute button on the GUI, a system command to transact the amenity rate change record within the server, wherein the client device launches a second screen within the GUI in response to the user pressing the execute rate change button, the second screen within the GUI comprising:
a confirmation that the system command to transact the amenity rate change record has been transmitted to the server;
receiving from the client device, by the server via the network, the system command to transact the amenity rate change record within the server; and
transacting, by the server, the amenity rate change record, wherein the transacting the amenity rate change record changes the current in-house amenity rate to match the proposed in-house amenity rate.

11. The method of claim 10, the first screen further comprising:
(F) a user selection mechanism enabling the user of the client device to choose a different competing online amenity provider from the list of competing online amenity providers,
wherein the client device launches a second screen within the GUI in response to the user using the user selection mechanism to choose a different competing online amenity provider, the second screen within the GUI comprising (A) with regard to the different competing amenity provider and (B)-(F).

12. The method of claim 10, further comprising:
transmitting to the client device, by the server via the network, a confirmation of the amenity rate change record transaction within the server, wherein the client device launches a third screen within the GUI in response to receiving the confirmation of the amenity rate change record transaction, the third screen within the GUI comprising:
a confirmation of the amenity rate change record transaction, and
a generate new record button that when pressed causes the client device to transmit to the server via the network a system command to generate a new amenity rate change record within the server based on newly acquired amenity rates and including corresponding calculated newly acquired amenity rate changes, a statistical comparison of the newly acquired amenity rates, a new current in-house amenity rate, and a new proposed in-house amenity rate.

13. The method of claim 10, the first screen within the GUI further comprising:
a graphical representation of a comparison of a first predicted revenue based on the current in-house amenity rate and a second predicted revenue based on a proposed transaction of the amenity rate change record, and/or
a graphical representation of a comparison of a first predicted occupancy rate based on the current in-house amenity rate and a second predicted occupancy rate based on the proposed transaction of the amenity rate change record.

14. The method of claim 10 wherein the amenity rate is an overnight stay rate.

15. The method of claim 10 wherein the predefined time interval is one hour.

16. The method of claim 10 wherein the statistical comparison includes calculating an average, a median, a mode, and/or a standard deviation.

17. The method of claim 10 further comprising:
prior to acquiring the amenity rates corresponding to each of the competing online amenity providers, editing, by the user, the list of competing online amenity providers.

18. The method of claim 17 wherein the editing the list of competing online amenity providers includes adding an additional amenity provider to the list and/or removing an amenity provider from the list.

19. The method of claim 10 wherein the list of competing online amenity providers includes competing online amenity providers, each with a physical location within a chosen geographic area.
